(19) United States
(12) Patent Application Publication
(10) Pub. No.: US 2008/0140253 A1
(43) Pub. Date: Jun. 12, 2008

(54) AUTOMATED SELF POWERED WASTE CONTAINER

(76) Inventor: ROHN A. BROWN, Tucson, AZ (US)

Correspondence Address: C. Robert von Hellens;CAHILL, von HELLENS & GLAZER P.L.C., 155 Park One, 2141 East Highland Avenue, Phoenix, AZ, 85016, US

(21) Appl. No.: 11/609,808

(22) Filed: Dec. 12, 2006

(51) Int. Cl. G06F 19/00

(52) U.S. Cl. 700/245; 701/23

(57) ABSTRACT

An automated self propelled refuse container travels from a parking or storage location to a refuse discharge location and return in response to a control unit cooperating with a tracking unit to control the direction of travel. Power is provided by an electric motor associated with each of two driving wheels rotating at the same rate and a third steering wheel provides stability and control over the direction of travel. The two driving wheels may rotate at a constant rate for straight line travel or charge direction, respectively, and a castering wheel provides stability and accommodates the direction of travel. Alternatively, a single wheel can provide both motive power and steering capability under control of a control unit responsive to the tracking unit and a pair of free wheeling wheels provide stability.

### CROSS REFERENCE TO RELATED APPLICATIONS

The present application is related to a provisional patent application entitled “Automated Trash Can” filed Nov. 2, 2005 and assigned Ser. No. 60/732,872 and describing an invention invented by the present inventor.

### BACKGROUND OF THE INVENTION

1. Field of the Invention

The present invention relates to rollout refuse containers that travel automatically from a parking location to a curb for mechanical pick up and emptying by a garbage truck and return empty to the parking location.

2. Description of Related Prior Art

Conventional and widely used waste or refuse containers are of a molded plastic material having a hinged lid and four to five feet tall. Such a container includes a pair of wheels at the back side beneath a bar useable to pull the container by rolling it along the ground. Upon righting the container, the bottom edge of the front side rests on the ground and provides sufficient frictional contact with the ground to prevent rolling except on relatively steep inclines.

Presently, these refuse containers are usually parked at the end of a driveway adjacent a residence or behind a fence or wall to avoid visibility from the street. Once or twice a week, a garbage truck comes by the curb end of the driveway of the residence to mechanically pick up, lift and empty the contents of a refuse container into a bin of the garbage truck. Thereafter, the empty container is set on the ground adjacent the curb. The garbage truck includes a pair of curved arms that open to grip the refuse container therewithin and thereafter close to engage the container with sufficient force to automatically lift the refuse container and turn the refuse container upside down above the bin to cause the refuse to fall out of the refuse container into the bin. Thereafter, the pair of arms rotate the refuse container to an upright position and set it on the ground by the curb.

The refuse container has to be delivered to the curb, usually along a driveway. If the driveway is essentially horizontal, the force required to do so, even with a filled refuse container is manageable by most people. However, those with physical handicaps or of limited strength may have great difficulty in moving a filled refuse container to the curb and bringing back the emptied refuse container. If the driveway is inclined, the difficulty of moving the refuse container is exacerbated. If the driveway is inclined downwardly toward the curb, it requires a significant amount of strength to keep the refuse container from rolling too fast and going out of control. To pull an emptied refuse container up a driveway may create difficulty.

Various automated refuse containers cooperating with special purpose refuse collection vehicles have been developed. However, such systems are generally not of commercial merit as the refuse containers are non standard compared to the types of refuse containers presently widely used throughout the country in combination with refuse collection trucks having specifically configured gripping arms and mechanisms for lifting, emptying and returning the refuse containers to the curb.

### SUMMARY OF THE INVENTION

A rollout refuse container includes motive means for driving and steering a third wheel to permit locomotion of the refuse container along the ground. A tracking unit, which may be based upon any of several types of tracking systems, provides guidance for travel of the refuse container from a parking location to a location for pick up by a refuse collection truck and return to the parking location. Alternatively, a swiveling third wheel may be incorporated and a pair of driving wheels are independently actuated to provide both locomotion and steering by modifying the rate of rotation of one driving wheel with respect to the other. A further embodiment may incorporate a pair of driving tracks on opposed sides of the refuse container to provide locomotion and steering by differential speed of the driving tracks. To assist a three wheeled refuse container to traverse soft ground, the wheels may be wide or incorporate balloon tires to increase the footprint of each wheel and thereby reduce the possibility of the refuse container becoming mired.

It is therefore a primary object of the present invention to provide an automated self propelled refuse container capable of independent travel from a parking location to a location for pick up by a refuse collection truck and return to the parking location.

Another object of the present invention is to provide motive means and tracking means useable in conjunction with conventional refuse container to automate travel and tracking of such a refuse container.

Yet another object of the present invention is to provide a low cost self propelled automated refuse container by modifying an existing widely used refuse container to incorporate a drive mechanism and a tracking system.

Yet a further object of the present invention is to provide a parking station for use in conjunction with an automated self propelled refuse container to store the refuse container while it is being filled.

A further object of the present invention is to provide a parking station for an electric powered refuse container that provides the capability for automatic charging of the battery.

A still further object of the present invention is to provide apparatus that may be retrofitted in a conventional refuse container to provide motive and tracking means for the refuse container.

A yet further object of the present invention is to provide a method for automatically transporting a refuse container from a parking location to a refuse pick up location and return.

These and other objects of the present invention will become apparent to those skilled in the art as the description thereof proceeds.

### BRIEF DESCRIPTION OF THE DRAWINGS

The present invention will be described with greater specificity and clarity with reference to the following drawings, in which:

FIG. 1 is a perspective view of a conventional refuse container modified to incorporate the present invention;

FIG. 2 is a cross sectional view of the refuse container shown in FIG. 1 and illustrating the power, tracking and control systems incorporated therein;

FIG. 3 is a detailed view of the steering wheel and related control systems;

FIGS. 4A, 4B and 4C illustrate representative apparatus for teaching the control system shown in FIG. 3 the path to be taken by the refuse container;

FIG. 5 illustrates the rear view of an alternative embodiment of the motive and steering mechanism for the refuse container;

FIG. 6 is a cross sectional view illustrating the motive means for transporting the refuse container shown in FIG. 7;

FIG. 7 illustrates a refuse container having track wheels;

FIG. 8 illustrates the refuse container mounted upon balloon tires;

FIG. 9 is a flow diagram the control systems for the refuse container;

FIG. 10 illustrates a parking station for the refuse container;

FIG. 11 is a top view of the parking station;

FIG. 12 is a side elevational view of the parking station;

FIG. 13 is a front elevational view of the parking station;

FIG. 14 illustrates representative control systems in the refuse container and in the parking station;

FIG. 15 is a flow diagram illustrating control systems attendant the parking station;

FIG. 16 illustrates a side view of the cart embodying the present invention for transporting a refuse container; and

FIG. 17 is a rear view of the cart and refuse container shown in FIG. 16.

### DESCRIPTION OF THE PREFERRED EMBODIMENT

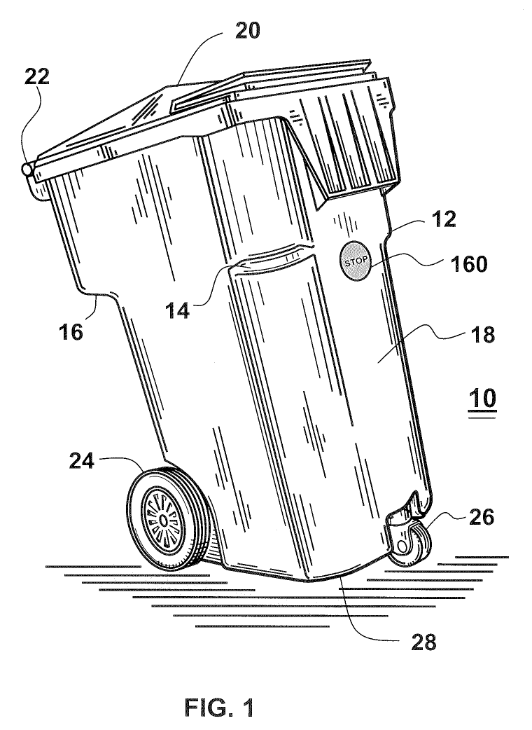

Referring to FIG. 1, there is shown rollout a refuse container 10 which is essentially of the conventional type that is widely used with garbage trucks having apparatus for lifting, emptying and lowering the refuse container. More particularly, the garbage trucks have a pair of curved arms which are actuated to grip refuse container 10 below shoulders 12, 14 and 16 and a further shoulder like shoulder 16 at the diametrically opposed side from shoulder 14. Front 18 of the refuse container faces the garbage truck upon engagement by the curved arms. The pair of curved arms close to grip the container and are then raised along a track. The track has a curve toward the bin of a garbage truck such that the refuse container is caused to rotate to a point close to vertical. Upon such rotation, lid 20 of the refuse container pivots about a hinge at the rear to expose the upper opening of the refuse container and permit the refuse to slide out of the refuse container and into the bin of the garbage truck. Thereafter, the pair of arms reverse course along the track to deposit the refuse container on the ground. The arms are expanded laterally to release the refuse container and are withdrawn to permit forward motion of the garbage truck without any contact of the refuse container. At most localities, a home owner or occupant of a residence must transport refuse container 10 to the curb to render it accessible to the garbage truck. After emptying, the refuse container must be retrieved and brought to its normal parking place, usually at the end of a driveway by a residence.

Usually, the refuse container must be pushed or pulled to the curb either the night before or early in the morning of the day of garbage pick up. Thereafter, the refuse container must be transported from the curb and returned to its parking or storage location. For some residents who are not physically fit, to move the refuse container may be almost overwhelming. Should the driveway be inclined downwardly toward the curb, the movement of a heavily loaded refuse container may be difficult to control. Moreover, to draw the refuse container up to its storage location, even though empty, may be a difficult physical task. It is the function and purpose of the present invention to permit automatic transport of the refuse container to and from the curb to alleviate the strain and potential injury that may result from manually transporting the refuse container.

As shown in FIG. 1, refuse container 10 includes a bar or handle 22 for manipulating the refuse container. A pair of wheels, of which wheel 24 is shown, permit rolling of the refuse container after it has been tilted by gripping handle 22. A conventional refuse container does not include third wheel 26, as illustrated in FIG. 1. Instead, bottom 28 at the front of the refuse container rests upon the ground. The purpose of wheel 26 is to provide a three point rolling support for the refuse container. The direction of movement is controlled by pivoting wheel 26 to cause the refuse container to move left, right, forward or backward.

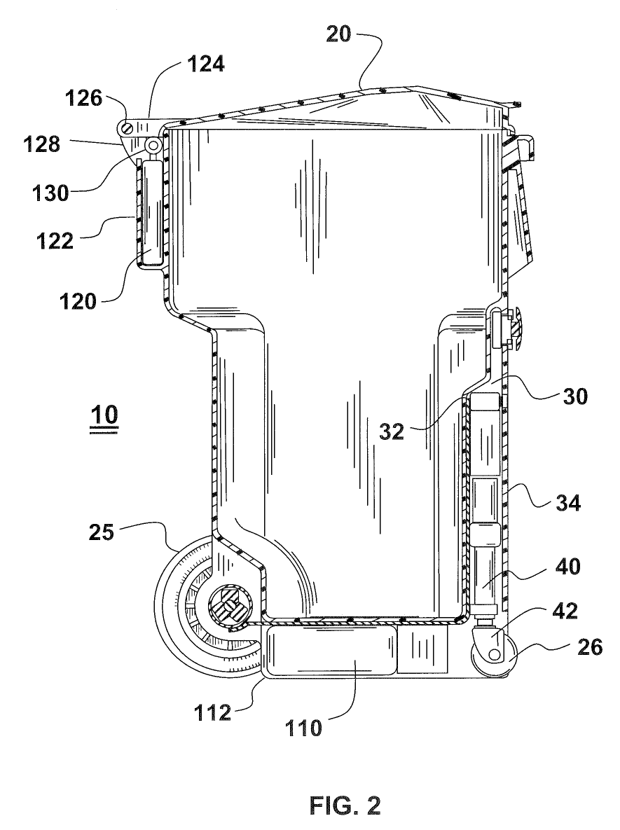

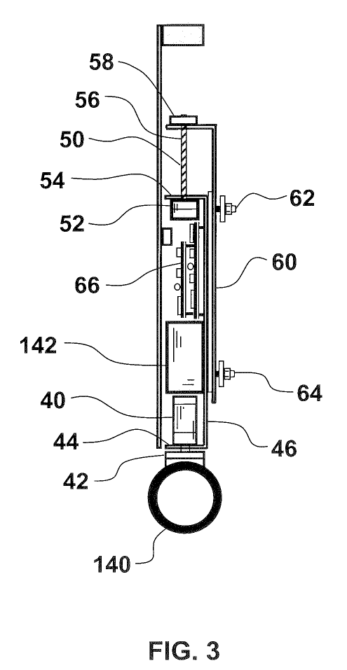

Referring jointly to FIGS. 2 and 3, the function and operation of wheel 26 will be described, assuming that wheels 24, 25 are the driving wheels. A compartment 30 is formed above wheel 26 to house various elements attendant operation of the wheel. This compartment may be formed by a wall 32 extending interiorly of wall 34 conventionally formed as part of front 18 of the refuse container. A steering motor 40 is mechanically coupled with fork 42 supporting wheel 26, which motor is attached to and supported by flange 44 of sliding member 46. Upon actuation of the steering motor, wheel 26 will be caused to pivot. A jack screw mechanism 50 includes a motor 52 secured with flange 54 of sliding member 46. A jack screw 56 engages jack nut 58. A frame 60 is secured to front 18 of refuse container 10 by mounting elements 62, 64, each of which elements may include a conventional nut and washer to secure the frame to the front of the refuse container. Upon activation of motor 52 of jack screw mechanism 50, jack screw 56 will rotate in threaded engagement with jack nut 58. This will cause sliding member 46 to move upwardly and thereby retract wheel 26 to a location above the bottom of the refuse container. With such retraction, the refuse container will not roll due to the friction between its bottom and the ground. Moreover, when wheel 26 is retracted, it will not be damaged during raising of the refuse container off the ground or placing the refuse container on the ground by the lifting arms of the garbage truck.

A control unit 66, which may include a processor and various circuitry subject to input signals will control operation of steering motor 40 and jack screw mechanism 50.

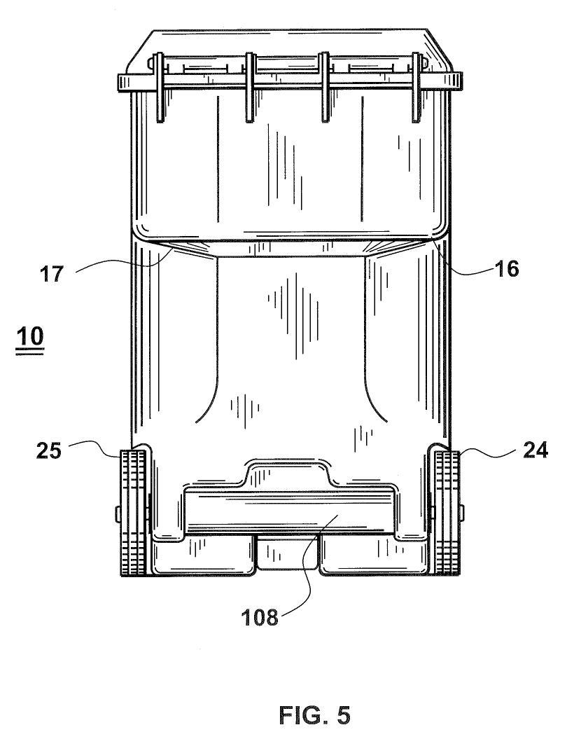

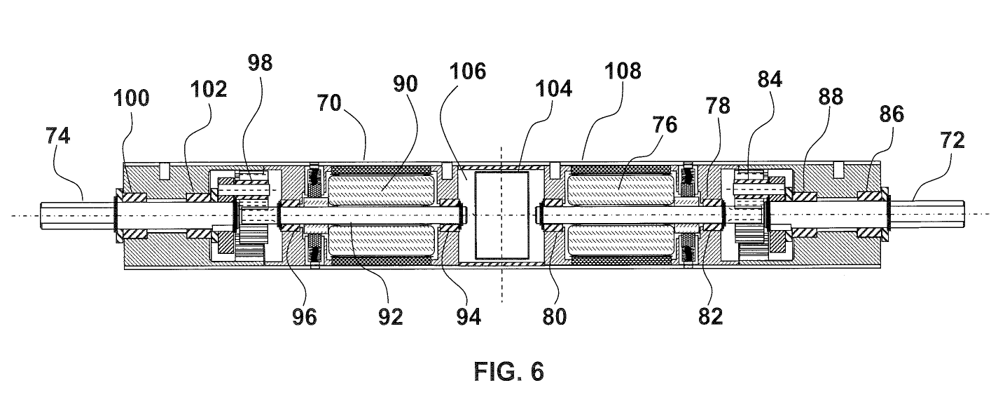

Referring jointly to FIGS. 5 and 6, motive means for transporting refuse container 10 will be described in further detail. Each of wheels 24, 25 is mounted upon axles 72, 74 of power unit 70. An electric motor 76 includes an output shaft 78 that may be mounted in bearings 80, 82 and extend into a gear box 84. An output gear of the gear box causes rotation of shaft 72 supporting wheel 24, which shaft may be journaled in bearings 86, 88. It is to be understood that motor 76 may be caused to rotate in either direction with commensurate rotation of wheel 24 mounted on shaft 72. A further motor 90 causes rotation of output shaft 92 journaled in bearings 94, 96. The output shaft is connected to a gear box 98 having an output gear for driving shaft 74 supporting wheel 25. As illustrated, the shaft is mounted within bearings 100, 102. Motor 90 is capable of rotating in either direction to provide a commensurate direction of rotation of shaft 74 and wheel 25 attached thereto. A control unit 104 for controlling operation of motors 76, 90 may be mounted within space 106 intermediate the motors. The motors, gear boxes and related equipment may be mounted within a cylinder 108 secured to refuse container 10 to locate wheels 24, 25 at the conventional locations. As shown in FIGS. 2 and 5, one or more batteries 110 for motors 76, 90 may be located within a compartment 112 depending from the bottom of refuse container 10.

As shown in FIG. 2, lid 20 may be manually operated in the conventional manner. Alternatively, it may be automated by an actuator 120 mounted within compartment 122 at the rear of refuse container 10. Actuator 120 includes a plunger 130 in operative engagement with bar 124 to exert an upward force upon the bar and cause raising of the lid. In such event, lid 20 is pivotally attached by a bar 124 engaging a pivot 126 supported by a brace 128 attached to the refuse container. Actuator 120 may be hydraulically or electrically actuated. Control of the actuator may be through a control unit, such as control unit 66 (see FIG. 3), for example. Upon energization of actuator 120, lid 20 will be raised and lowered on command.

As depicted in FIG. 3, wheel 26 may be a driving wheel which permits elimination of power unit 70 driving rear wheels 24, 25. A wheel motor 140 is in operative engagement with wheel 26 to cause the wheel to rotate on command in either direction. Electrical power for wheel motor 140, as well as for steering motor 40 and jack screw mechanism 50, may be provided by a battery 142. Control of these three motors can be effected by control unit 66.

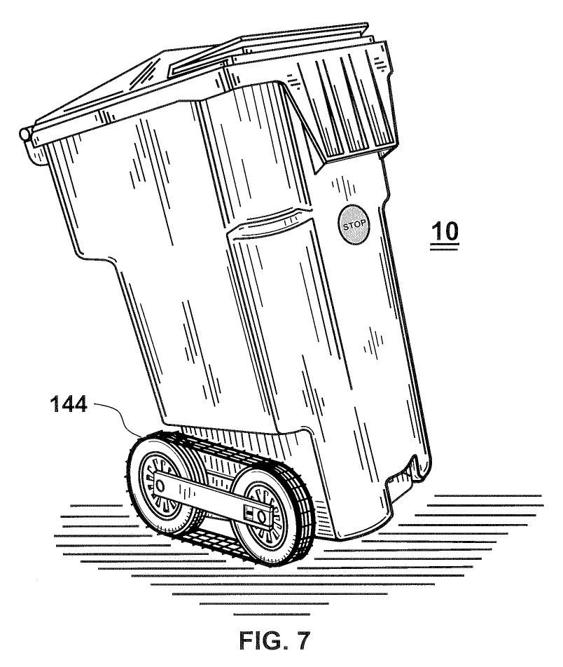

FIG. 7 illustrates a refuse container 10 having a pair of tracks 144 disposed on each side. These tracks provide traction over very soft ground, loose rocks and particularly snow. The tracks will also climb irregular terrain (such as drop off at the end of a driveway) better than the wheeled version illustrated in FIG. 1. Additionally, by operating at different speeds, turning movement of the refuse container is achieved. It is to be understood that operation of the two tracks is controlled by a control unit working in tandem with a tracking unit to be described.

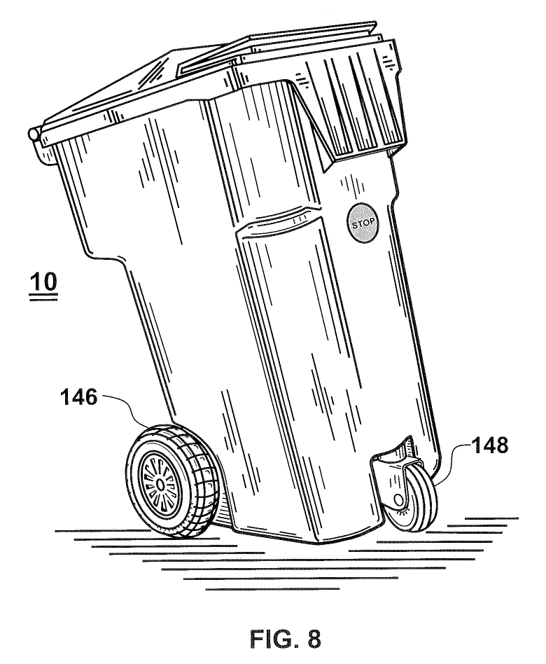

FIG. 8 illustrates a refuse container 10 having wide wheels 146, 148 to accommodate soft ground and to prevent the wheels from becoming mired in either mud or snow.

To permit automated transport of the container between its storage location and the curb, a guidance system is necessary. Such guidance system may take any one of several forms. A global positioning system (GPS) may be employed. However, the resolution available from such a system may not be sufficiently fine to permit accurate positioning of the refuse container at the storage location and at the curb. To improve accuracy of the track followed by the refuse container, a magnetic strip placed along the desired track may be used. Such a strip would be sensed by a sensor on the refuse container to control the direction of travel both to and from the storage location. At locations wherein the track is unlikely to be covered by snow, a stripe may be painted along the track and light sensors on the refuse container would detect the stripe of paint and provide input signals to the control unit to maintain travel along the stripe. An electrically energized wire placed on the ground commensurate with the desired track or buried in the ground can be used to guide the travel of the refuse container. The electrical field generated by such wire can be sensed and provide the requisite control signals to the control unit to guide the travel of the refuse container.

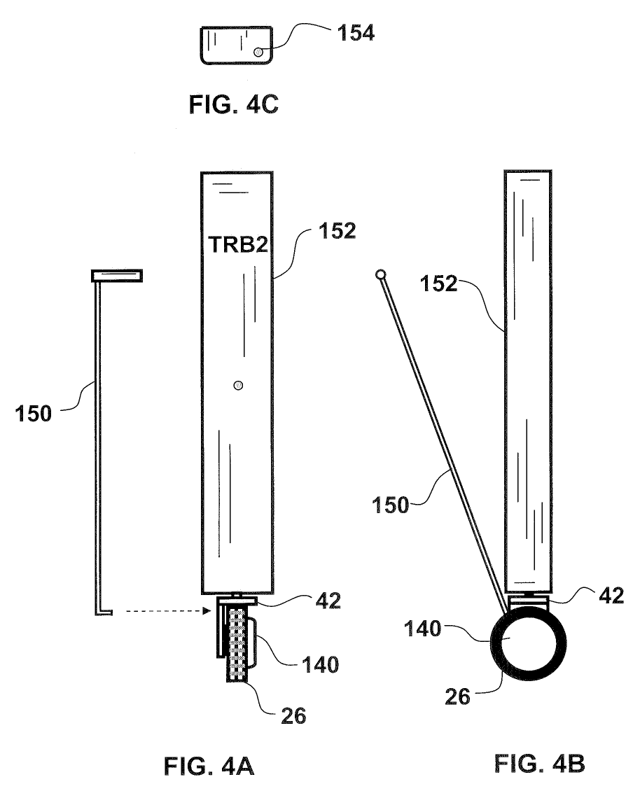

Referring to FIGS. 4A, 4B and 4C, there is shown a further guidance system similar to a dead reckoning system. The purpose of this system is to manually transport the refuse container along the desired track to manually control the speed, direction of travel and change in direction of travel commensurate with the desired track and recording such movement in a memory of the control unit. This may be accomplished by attaching a handle 150 to fork 42 pivotally extending from a representatively illustrated housing 152, which, in fact, corresponds with front 18 of refuse container 10. As shown in FIG. 4B, after attachment of handle 150, the refuse container would be transported along the intended path. As wheel 26 rotates, a signal would be generated by motor 140 reflective of the speed of rotation. Data attendant such signal would be stored in a memory of the control unit. Similarly, any rotation of fork 42 would produce rotation of the armature of motor 40 (see FIG. 2) and generate a signal. This signal would also be stored in the memory of a control unit. To initiate this “teaching” of the path to be followed by the refuse container, a button 154 or other switch would first be actuated. After such manual transport of refuse container 10, the path from a storage location of the refuse container to the curb and return would be recorded in the memory of the control unit. Thereafter, upon actuation of the automated system, the trash container would travel in the path “taught” at a predetermined speed. After arrival at the curb, wheel 26 would be retracted. Retraction of wheel 26 prior to engagement of the refuse container by the arms of the garbage truck would terminate control inputs to motivate the refuse container. Upon subsequent extension of wheel 26 after the refuse container was placed on the ground by the arms of the garbage truck, the control system would cause the refuse container to return to its storage location.

Various ancillary sensors may be incorporated for safety or other reasons. For example, a proximity sensor may be used to prevent damage by contact of an immobile or mobile element/person. To prevent inadvertent spillage of refuse by the refuse container tilting, a tilt sensor may be incorporated. Various optical apparatus may be used as a sensor to prevent collision with a object or person. By suitable programming, such optical apparatus may even be used to control the direction of travel and rate of travel of the refuse container.

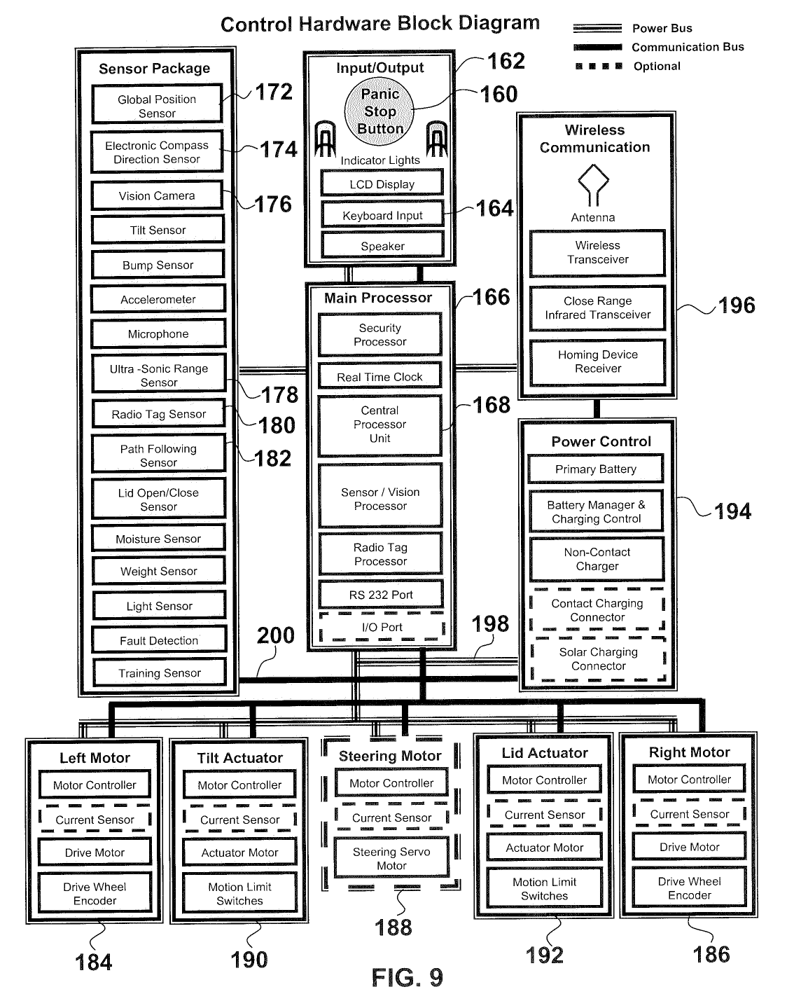

Referring to FIG. 9, there is shown a block diagram of various controls that may be incorporated and their respective functions. Necessarily, certain of these controls require hardware in the form of sensors, switches of various sorts and various further components for generating signals in response to certain inputs. As the flow diagram is self explanatory, recapitulation of the various elements need not be recited. However, it may be beneficial to point out that refuse container 10 may include a panic button 160, as illustrated in FIGS. 1 and 9, to immediately terminate movement.

As illustrated in FIG. 9, any or all of numerous sensors, controls and actuators may be incorporated in the control unit of the refuse container or as several interconnected modules. An input/output module 162 may include primary controls for operation of the refuse container, as represented by keyboard input 164. Various other features, as illustrated, may be incorporated therein. A processor module 166 includes a central processor unit 168, generally referred to as a microprocessor, for controlling operation related to activation and movement of the refuse container. A sensor module 170 may include any or all of a plurality of sensors identified in FIG. 9. Certain of these sensors are related to and a function of the tracking unit incorporated with the refuse container to control travel of the refuse container. In particular, the tracking unit may incorporate any of global position sensor 172, electronic compass direction sensor 174, vision camera 176, ultra sonic sensor 178, radio tag sensor 180, and path following sensor 182. It is to be understood that the ground across which the refuse container is to travel from its storage location to the location of discharge of refuse and return may be denoted by a length of wire to be sensed, whether or not it is electrically charged, a plurality of magnets or magnetic strip to be sensed or other path denoting element that is readily sensed to control the direction of travel of the refuse container. Alternatively, a global positioning unit programmed to control travel of the refuse container in accordance with a preset path may be used. A system of dead reckoning preset in the microprocessor may be incorporated. It is to be understood that the various other tracking units may be embodied with the invention.

Depending upon which embodiment of driving wheels and steering wheels are embodied in the refuse container, different control modules would be activated. Control module 184 would be activated to control operation of the left motor 76 (see FIG. 6) and control module 186 would be activated to control the right motor 90 (see FIG. 6) in the case where the pair of wheels at the rear of refuse container 10 are the driving wheels. In the event wheel 26 at the front of the refuse module is both the driving wheel and the steering wheel (see FIG. 3), control module 188 would be actuated. Tilt actuator module 190 is actuated to raise and lower wheel 26 at the front of the refuse container to avoid damage thereto during the process of having the refuse container raised and lowered by the garbage truck. If lid 20 is to be raised and lowered on command, lid actuator module 192 would be incorporated. Power for operating the driving wheels, the steering wheel and the control unit, including the tracking unit, is provided by power module 194. It includes not only one or more batteries to provide a source of electrical power but also the capability for effecting charging of the battery, preferably at the storage location. Under certain circumstances, it may be beneficial to provide the capability for wireless communication with the control unit of the refuse container. Wireless communication module 196 provides this capability. It is to be understood that such wireless communication may be unmanned and self regulating between the refuse container and a fixed location to control travel and other operations of the refuse container. As indicated, a power bus 198 interconnects power control module 194 with each of the other modules to provide electrical power as required. Communication bus 200 interconnects main processor module 166 with each of the remaining modules to control their respective operations.

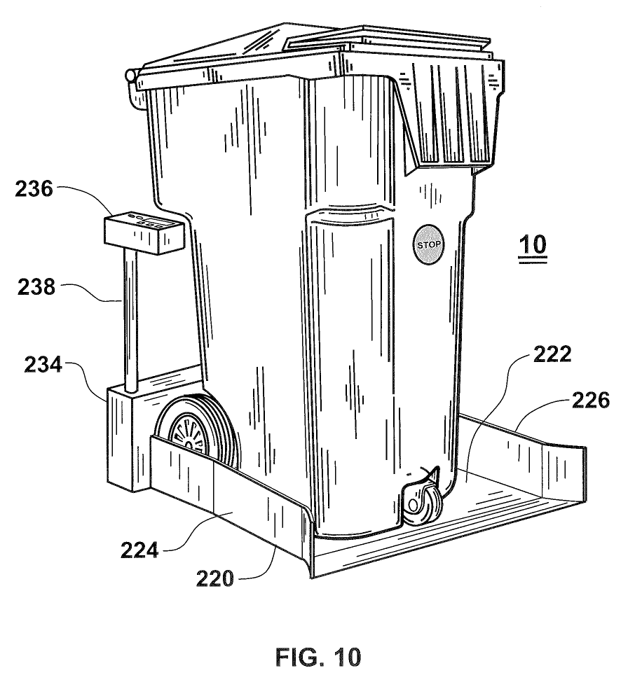

Referring jointly to FIGS. 10, 11, 12 and 13, there is shown a parking station 220 equivalent to the above-discussed storage location. The parking station includes a platform 222 for supporting refuse container 10. Side rails 224, 226 may extend from the platform to guide entry of the refuse container. Platform 222 may include non-skid surfaces 228, 230 to insure traction of the drive wheels located at the rear of refuse container 10. In the event wheel 26 at the front of the refuse container is the driving wheel, a further non-skid surface would be incorporated for engagement by this wheel. If the charging unit for the battery(ies) embodied in the refuse container is mounted at the bottom of the refuse container, an induction charger interface 232 may be located upon platform 222 to effect charging of the battery(ies). A module 234 may be located at the rear of parking station 220 to house the various components attendant the refuse container. A keypad/display module 236 may be mounted on a stanchion 238 extending from module 236. It will provide means for controlling operation of the parking station and to provide visual cues of various functions to be performed and being performed. A power cord 240 may be used to interconnect module 234 with a source of power. Additionally, a cord 242 may be used to interconnect module 234 and the equipment therein with the internet or with a telephone wire.

In summary, parking station 220 provides the capability of maintaining the batteries within the refuse container fully charged and provides the capability for controlling operation and travel of the refuse container in accordance with a preset pattern. Additionally, it can provide an indication of the status of various components and the capability for interconnecting the control unit of the refuse container with a remote location.

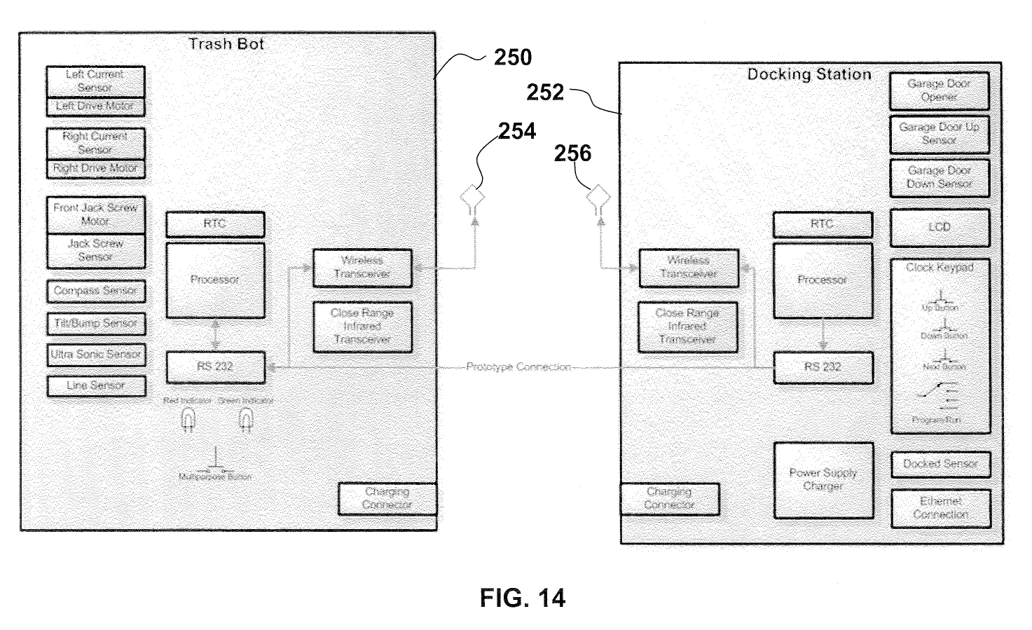

FIG. 14 illustrates in block diagram the functional relationship between the parking station 220 (see FIG. 10) and the refuse container 10. As illustrated within block 250, various modules and sensors for determining operation of certain components in the refuse container are recited. Block 252 depicts various functions that may be incorporated in the docking station with the control unit of the refuse container. Communication therebetween may be provided by wireless communications, as reflected by antennae 254, 256, respectively.

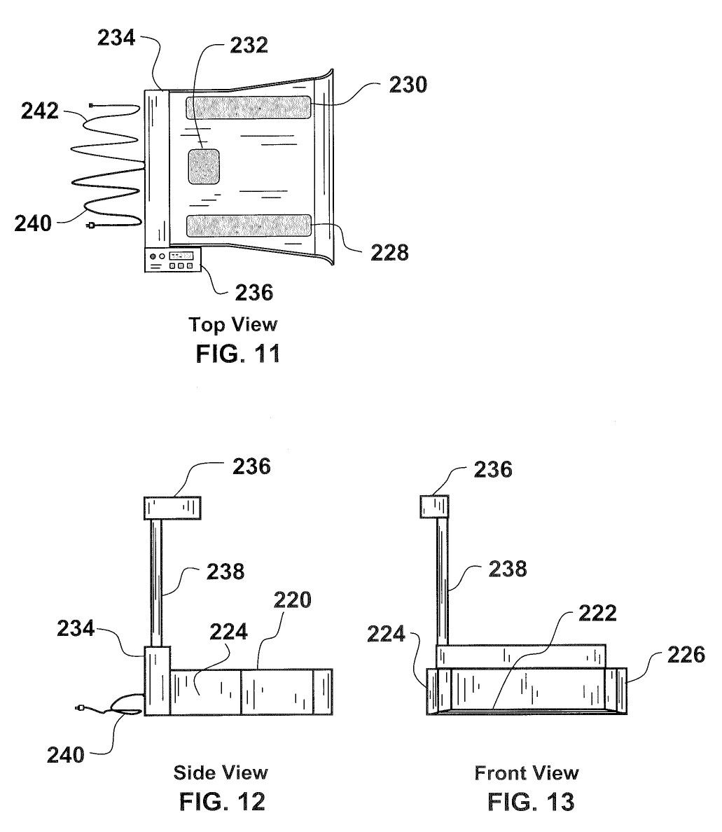

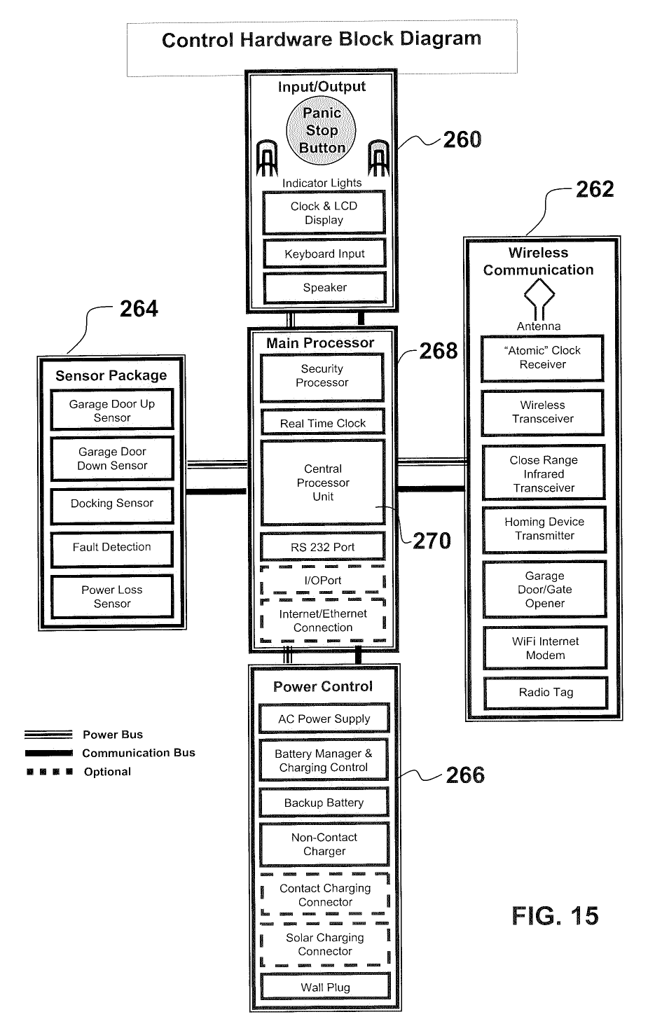

FIG. 15 is a further block diagram illustrating various modules that may be incorporated in parking station 220. In particular, block 260 represents certain functions that may be performable by keypad/display module 236 (see FIG. 11). Wireless module 262 includes several components, as listed, for communicating with the refuse container. Various sensors may be incorporated, as depicted in sensor module 264. Power module 266 includes various components relating to charging and maintenance of the battery(ies) embodied within the refuse container. As depicted, it may include a connector for charging by a solar panel and various other functions. Operation of these modules is controlled by processor module 268, which may be in the form of a microprocessor, as represented by a central processor unit 270. The processor module is interconnected with the remaining modules through a communication bus, as represented by the solid lines. Additionally, a power bus, represented by triple lines, provides power to the modules.

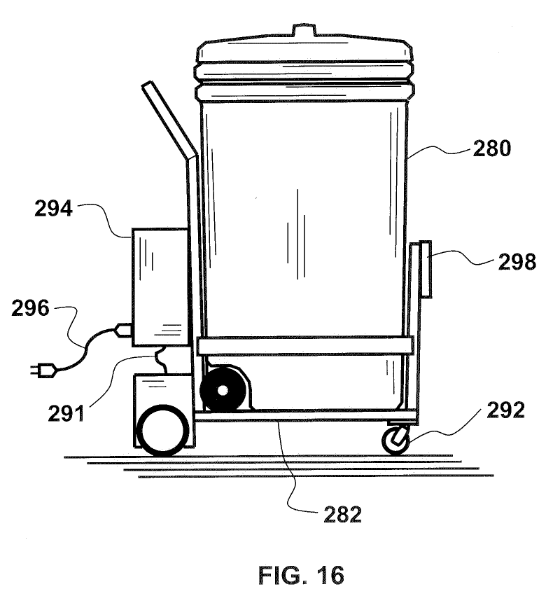

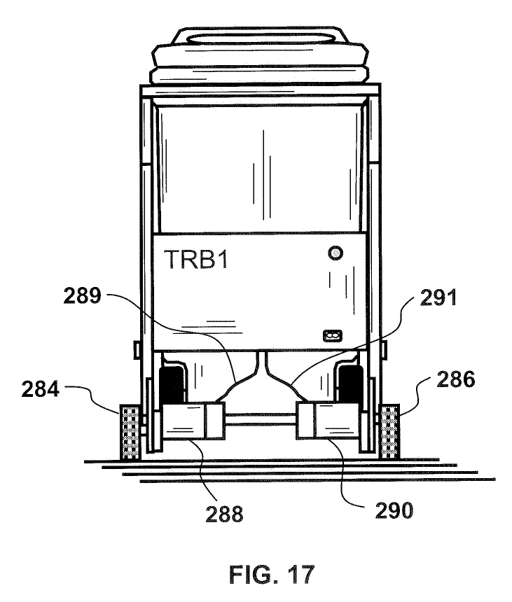

Referring jointly to FIGS. 16 and 17, there is shown a variant of the present invention. In particular, there is shown a refuse container 280 supported upon a cart 282. The purpose of the cart is to transport the refuse container from a storage location to a location for discharge of the contents of the refuse container and to return the refuse container to the storage location. All of the motive power units, steering units, tracking unit and various control systems are embodied in and mounted upon cart 282. Thereby, any configuration of refuse container may be used to achieve the desired result of a self propelled automated refuse container to alleviate the burden of manually transporting the refuse container to and from a refuse discharge location.

Cart 282 includes a pair of drive wheels 284, 286 receiving power from electric motors 288, 290, respectively. A front wheel or pair of front wheels 292 are of the castering type. By having wheels 284, 286 be the driving wheels and controlling their respective rate of rotation will provide the capability to bring about a change of direction of the cart and castering wheel(s) 292 will accommodate such change of direction. A module 294 includes a control unit for the cart, including a microprocessor, and one or more batteries to provide the requisite electrical power to electric motors 288, 290. Interconnection between electric motors 288, 290 and module 294 may be effected by conductors 289, 291. Additionally, it may include a charging circuit energized by a power cord 296 connected to an electrical outlet at the storage location. The front of cart 282 may include a module 298 for containing various sensors to effect tracking. That is, the module may embody a tracking unit to guide the cart to and from the storage location. Depending upon the particular system used for achieving tracking by the cart, module 298 may be mounted at the bottom of the cart to sense an in ground wire, magnetic strip, lighted strand, painted stripe or the like. Other tracking units, as described above, may also be incorporated to control the travel of the cart.

I claim:

1. A self propelled automated refuse container comprising in combination:
a) refuse container having a hinged lid;
b) at least one driving wheel for transporting said container;
c) at least one steering wheel for steering the direction of travel of said container;
d) a tracking unit for controlling the direction of travel of said container;
e) a microprocessor for controlling operation of said container; and
f) a source of power for operating said driving wheel, said steering wheel, said tracking unit and said microprocessor.

2. The self propelled automated refuse container as set forth in claim 1, wherein said steering wheel includes an electric motor for turning said steering wheel to control the direction of travel of said container.

3. The self propelled automated refuse container as set forth in claim 2 wherein said steering wheel comprises said driving wheel and including an electric motor for rotating said steering wheel to provide motive power.

4. The self propelled automated refuse container as set forth in claim 3 wherein said steering wheel includes an electric motor for turning said steering wheel to control the direction of travel of said container.

5. The self propelled automated refuse container as set forth in claim 3, including a jack screw for raising and lowering said steering wheel on command from said microprocessor.

6. The self propelled automated refuse container as set forth in claim 1, including means for selectively raising said lid.

7. The self propelled automated refuse container as set forth in claim 1 wherein said at least one driving wheel comprises a pair of wheels and including a first electric motor for rotating one wheel of said pair of wheels and a second electric motor for rotating the other wheel of said pair of wheels to effect both travel of said container and to control the direction of travel of said container, said steering wheel being a castering wheel to accommodate a change in direction of travel of said container prompted by said pair of wheels.

8. The self propelled automated refuse container as set forth in claim 7, including a jack screw for selectively raising and lowering said castering wheel.

9. The self propelled automated refuse container as set forth in claim 1, including a parking station for storing said container, said source of power comprising a battery and said parking station including a further source of power for charging said battery.

10. A method for transporting a refuse container from a storage location to a location for discharge of the contents of the refuse container and return, said method comprising the steps of:
a) energizing at least a driving wheel to cause travel of the container;
b) controlling the direction of travel of the container with at least a steering wheel;
c) directing travel of the container along a predetermined track to and from the discharge location; and
d) terminating travel of the container upon return to the storage location.

11. The method as set forth in claim 10 wherein said step of energizing is carried out by a pair of driving wheels, each driving wheel including an electric motor selectively activated to provide motion for the container and to provide direction of travel of the container to carry out said step of controlling.

12. The method as set forth in claim 10 wherein said step of controlling is carried out by an electric motor turning a single steering wheel and wherein said step of energizing is carried out by a further electric motor rotating the single steering wheel.

13. The method as set forth in claim 12, including the step of raising the single steering wheel upon arrival of the container at the discharge location and the step of lowering the single steering wheel prior to return of the container to the storage location.

14. The method as set forth in claim 10, including the step of providing electric power from a battery to carry out said steps of energizing, controlling, directing and terminating.

15. The method as set forth in claim 14 including the step of charging the battery at the storage location.

16. A self propelled automated refuse container comprising in combination:
a) a refuse container including a hingedly attached lid for receiving and discharging refuse;
b) a pair of wheels mounted at the rear of said refuse container, each of said wheels including an independently activated electric motor for driving the respective wheel;
c) a castering wheel mounted at the front of the refuse container to accommodate forward and backward travel and change of direction of said refuse container;
d) a tracking unit for controlling the direction of travel of said refuse container from a storage location to a refuse discharge location and return; and
e) a microprocessor for controlling the travel of said refuse container.

17. The method as set forth in claim 16, including means for raising said castering wheel upon arrival at the discharge location and for lowering said castering wheel prior to return of said refuse container to the storage location.

18. The method as set forth in claim 16, including means for selectively raising and lowering said lid.

19. A self propelled automated refuse container comprising in combination:
a) a refuse container, including a hingedly attached lid for receiving and discharging refuse;
b) a pair of wheels mounted at the rear of said refuse container for rolling said refuse container;
c) a steering and driving wheel mounted at the front of the container including a first electric motor for driving said steering wheel to provide locomotion for said refuse container and a second electric motor for turning said steering wheel to control the direction of travel of said refuse container;
d) a tracking unit for controlling the direction of travel of said refuse container from a storage location to a refuse discharge location and return; and
e) a microprocessor for controlling the travel of said refuse container.

20. The method as set forth in claim 19, including means for raising and lowering said steering and driving wheel upon arrival at discharge location and for lowering said steering and driving wheel prior to return of said refuse container to the storage location.

21. The method as set forth in claim 19, including means for selectively raising and lowering said lid.
